(19) United States
(12) Patent Application Publication
(10) Pub. No.: US 2011/0105197 A1
(43) Pub. Date: May 5, 2011

(54) Universal mutilmedia bluetooth car handsfree device

(76) Inventor: Tonny Chen, Shengang Shiang (TW)

(21) Appl. No.: 12/588,978

(22) Filed: Nov. 4, 2009

(51) Int. Cl. H04M 1/00

(52) U.S. Cl. 455/569.2

(57) ABSTRACT

A universal multimedia bluetooth car handsfree device, aims to transmit signals stored in various types of multimedia storage devices to a car stereo for broadcasting. It includes a bluetooth wireless transmission unit, a handsfree speakerphone unit, a stereo switch unit, a cable signal input unit, a control unit, and a stereo output unit. It is connected to a car stereo and allows the common car stereo to have additional handsfree bluetooth speakerphone function and the ability to connect in wired or wireless fashion to various types of handheld media storage devices to play music.

### BACKGROUND OF THE INVENTION

1. Field of the Invention

The present invention relates to a universal multimedia bluetooth car handsfree device, and more particularly to a universal multimedia bluetooth car handsfree device that is able to transmit signals stored in various types of multimedia storage devices to a car stereo for playing.

2. Description of the Prior Art

Because the popularity of bluetooth technology, various types of mobile phones are able to support wireless communication in bluetooth protocol. As a result, users can easily perform handsfree communication anywhere anytime. Taiwan patent application No. 92200595, entitled “Bluetooth handsfree mobile phone built-in a car stereo” discloses a technique which automatically transfers a coming call to a car stereo to enable a driver to do conversation through a handsfree. Furthermore, with advanced technologies of the Internet and music compression, aside from the traditional music sources and storage means such as cassette, CD, AM/FM, etc., the compressed music obtained through the Internet can be stored in various storage devices such as flash memory cards, USB storage devices, and various types of MP3 players. However, no car stereo in the market to date can be connected to the various types of multimedia storage devices mentioned above through bluetooth communication, so it is very inconvenient in use.

### SUMMARY OF THE INVENTION

In view of the above said problems, the main object of the present invention is to provide a universal multimedia bluetooth car handsfree device that is able to transmit signals stored in various types of multimedia storage devices to a car stereo for playing. It includes a bluetooth wireless transmission unit, a handsfree speakerphone unit, a stereo switch unit, a cable signal input unit, a control unit, and a stereo output unit. By connecting the invention to a car stereo, the common car stereo can provide the function of a bluetooth handsfree speakerphone and play music stored in various types of multimedia storage devices.

When a call coming from a bluetooth enabled mobile phone, the universal multimedia bluetooth car handsfree device of the present invention can connect it in a two-way monotone wireless mode through the bluetooth wireless transmission unit. The handsfree speakerphone unit receives user's voices through a connected microphone and transmits them to the caller at the opposite side, while the voices of the caller at the opposite side are transmitted through the bluetooth wireless transmission unit, stereo switch unit, and handsfree speakerphone unit, and broadcast through a speaker of the car stereo, so that the user can do conversation without holding the mobile phone. When there is a desire to play music through the bluetooth enabled mobile phone, through the connection with the bluetooth wireless transmission unit in an one-way stereo wireless mode, the control unit controls and switches the input channel of the stereo switch unit to the bluetooth wireless transmission unit; while the mobile phone music reaches the car stereo through the bluetooth wireless transmission unit, stereo switch unit, and stereo output unit, and is connected to the car stereo switch unit through one of input interfaces, so that the user can enjoy the mobile phone music through the car stereo by switching the car stereo switch unit to the input interface channel.

The universal multimedia bluetooth car handsfree device of the present invention further has a car stereo transmission circuit that allows the user to do inverse manipulation through a car stereo panel. By means of the car stereo, car stereo transmission circuit and bluetooth wireless transmission unit, operation signals can be sent back to the bluetooth enabled mobile phone in a wireless fashion to indirectly control play functions of mobile phone music, such as selection, playing, pause, and the like.

When the mobile phone is not in use to play music, and the multimedia storage device is connected to a cable signal input unit through a signal cable to play music, the music signal is transmitted to the cable signal input unit through the signal cable. The control unit controls the stereo switch unit to switch the input channel to the cable signal input unit so that sound signals are transmitted through the stereo output unit to the input interface of the car stereo as one of the sound sources of the car stereo. The user can enjoy the music stored in the multimedia storage device by merely switching the car stereo switch unit to the input interface channel.

The universal multimedia bluetooth car handsfree device of the present invention further has a multimedia transmission circuit that allows the user to do inverse manipulation through a car stereo panel by passing a control signal through the car stereo transmission circuit to the multimedia transmission circuit, and through a multimedia signal line to the multimedia storage device, to indirectly control the play functions of the multimedia storage device music, such as selection, playing, pause, and the like. The multimedia transmission circuit further includes a transmission protocol simulation circuit which includes various types of transmission protocols of multimedia storage device to facilitate connection of the cable signal input unit and various types of multimedia storage devices.

Since the control panel of most car stereos includes an interface to operate the multimedia player, and the car stereo usually provides the function of connecting a CD changer and also has reserved such a control interface, hence by simulating the music and control sequence of the multimedia storage device as a CD change, the user can operate the multimedia storage device or a bluetooth enabled mobile phone to play music as the CD changer. To meet this purpose, the present invention further has a CD changer simulation circuit to provide a connection with CD changer signal interface. Thereby the music of the multimedia storage device or mobile phone can be input to the car stereo through the connection with CD changer signal interface and played.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a block diagram of a first embodiment of the present invention;

FIG. 2 is a block diagram of a second embodiment of the present invention;

FIG. 3 is a block diagram of a third embodiment of the present invention;

FIG. 4 is a block diagram of a forth embodiment of the present invention;

FIG. 5 is a block diagram of a fifth embodiment of the present invention;

FIG. 6 is a block diagram of a sixth embodiment of the present invention;

FIG. 7 is a block diagram of a seventh embodiment of the present invention;

FIG. 8 is a block diagram of an eighth embodiment of the present invention; and

FIG. 9 is a block diagram of a ninth embodiment of the present invention.

### DESCRIPTION OF THE PREFERRED EMBODIMENTS

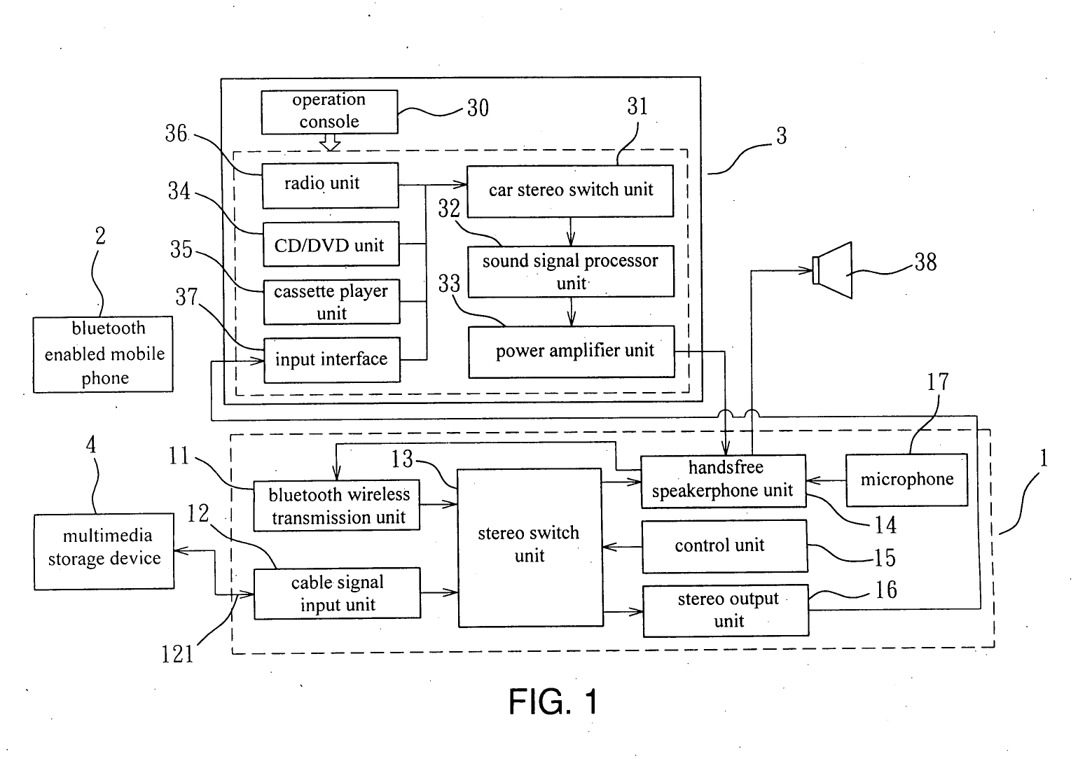

Please refer to FIG. 1 for a first embodiment of the present invention. The universal multimedia bluetooth car handsfree device 1 of the present invention includes a bluetooth wireless transmission unit 11, a cable signal input unit 12, a stereo switch unit 13, a handsfree speakerphone unit 14, a control unit 15 and a stereo output unit 16, and is connected to a car stereo 3 (which includes an operation console 30, a car stereo switch unit 31, a sound signal processor unit 32, a power amplifier unit 33, a CD/DVD unit 34, a cassette player unit 35, a radio unit 36, at least one input interface 37, and at least one speaker 38).

The bluetooth wireless transmission unit 11 has one end linking to a bluetooth enabled mobile phone 2 in a two-way wireless transmission fashion with output sound directly or indirectly linking to the handsfree speakerphone unit 14 and also serving as input to the stereo switch unit 13 to provide wireless transmission for the bluetooth enabled mobile phone 2 to perform handsfree conversation or music playing.

The cable signal input unit 12 provides input to at least one multimedia storage device 4 through at least one multimedia signal cable 121 and is connected to the stereo switch unit 13 to provide output to become input thereof;

The stereo switch unit 13 receives inputs from the bluetooth wireless transmission unit 11 and the cable signal input unit 12, and sends output to the stereo output unit 16 to become input thereof to control sound source selection during sound output.

The handsfree speakerphone unit 14 executes phone calls coming from the bluetooth enabled mobile phone 2 and carries out conversation through a microphone 17 and the speaker 38.

The control unit 15 controls the stereo switch unit 13 to control at least sound source input selection.

The stereo output unit 16 is directly or indirectly connected to the input interface of the car stereo 3 (such as AUX1, AV1, etc.) to provide another type of sound source selection for the car stereo 3 beside CD/DVD, AM/FM; or the like.

By means of the units set forth above, when the bluetooth enabled mobile phone 2 receives a coming call, the bluetooth wireless transmission unit 11 of the invention is connected in a two-way monotone wireless mode, and the control unit 15 controls the input channel of the stereo switch unit 13 to switch to the bluetooth wireless transmission unit 11. In the mean time, the handsfree speakerphone unit 14 receives user's voices through the microphone 17 and transmits the conversation back to the caller. Caller's voices are received through the bluetooth wireless transmission unit 11, stereo switch unit 13 and handsfree speakerphone unit 14 and amplified, and are broadcasted through the speaker 38 of the car stereo 3. Thus conversation can be accomplished without holding the mobile phone.

The present invention not only provides the basic handsfree function for the mobile phone, but also can be used to play music for the bluetooth enabled mobile phone 2. When the bluetooth enabled mobile phone 2 is used to play music, through the bluetooth wireless transmission unit 11 of the present invention, it is connected in an one-way stereo mode, and the control unit 15 switches the input channel of the stereo switch unit 13 to the bluetooth wireless transmission unit 11 to allow the music of the bluetooth enabled mobile phone 2 to be transmitted to the car stereo 3 through the bluetooth wireless transmission unit 11, stereo switch unit 13, and stereo output unit 16. In addition, by connecting the input interface 37 to the car stereo switch unit 31 of the car stereo 3, the user only has to switch (select) the car stereo switch unit 31 of the car stereo 3 to the channel of the input interface 37 to broadcast the music of the bluetooth enabled mobile phone 2 through the car stereo 3.

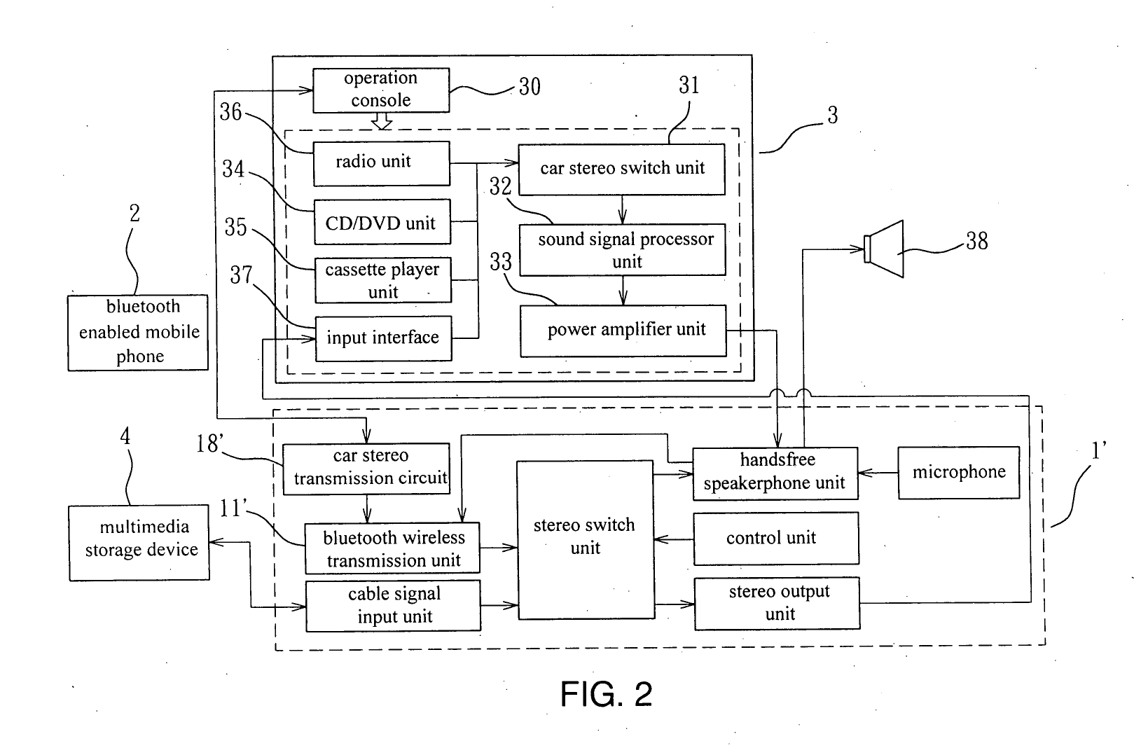

Please refer to FIG. 2 for a second embodiment of the present invention. The universal multimedia bluetooth car handsfree device 1′ of the invention further includes a car stereo transmission circuit 18′ to allow the user to perform inverse operation through the car stereo panel. Through an operation console 30 of the car stereo 3, car stereo transmission circuit 18′ and bluetooth wireless transmission unit 11′, operating signals can be sent in wireless mode to the bluetooth enabled mobile phone 2 to indirectly manipulate the music playing functions, such as selection, playing, pause, etc., for the bluetooth enabled mobile phone 2.

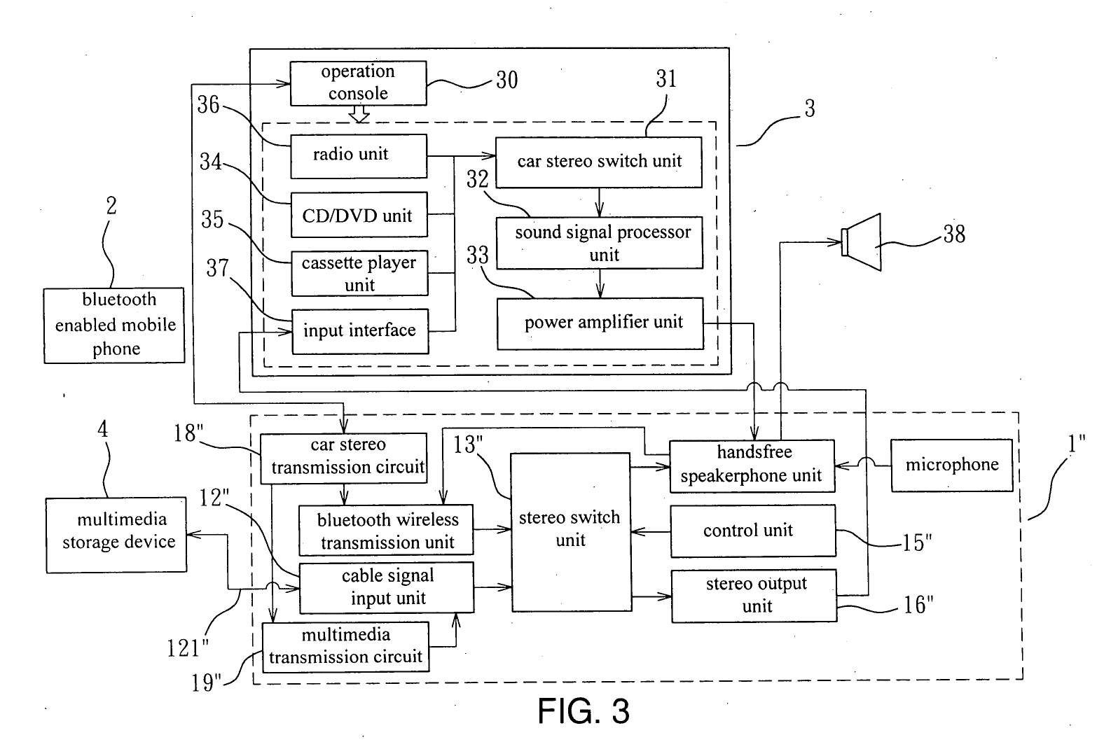

Please refer to FIG. 3 for a third embodiment of the present invention. Wherein the bluetooth enabled mobile phone 2 of the universal multimedia bluetooth car handsfree device 1″ of the invention is not being used to broadcast music. The multimedia storage device 4 (including storage device with non-volatile memory and various types of multimedia players equipped with memory) is connected to the cable signal input unit 12″ through the multimedia signal cable 121″. To play music, the music signal is transmitted to the cable signal input unit 12″ through the multimedia signal cable 121″, the control unit 15″ controls the stereo switch unit 13″ to switch the input channel to the cable signal input unit 12″, and the sound signal is transmitted to the input interface 37 of the car stereo 3 through the stereo output unit 16″ to become one of the sound sources of the car stereo 3. Hence the user only has to switch the car stereo switch unit 31 of said car stereo 3 to the channel of the input interface 37 to enjoy the music stored in the multimedia storage device 4.

Same as the bluetooth enabled mobile phone 2, aside from allowing the user to directly perform operation and control of the multimedia storage device 4, the universal multimedia bluetooth car handsfree device 1″ of the invention further has a multimedia transmission circuit 19″ that allows the user to perform inverse operation of the operation console 30 of the car stereo 3 so that, the control signal is transmitted through the car stereo transmission circuit 18″ to the multimedia transmission circuit 19″ and multimedia signal cable 121″ to the multimedia storage device 4 to indirectly perform music playing functions, such as selection, playing, pause, etc., for the multimedia storage device 4.

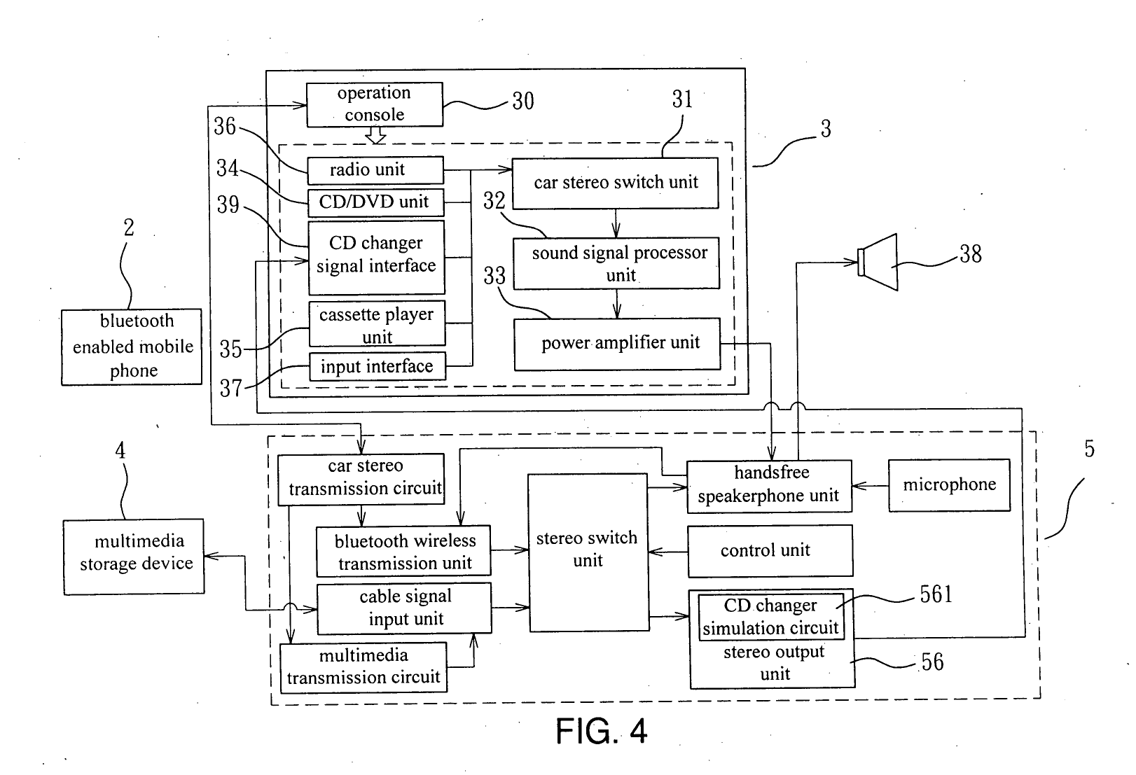

Please refer to FIG. 4 for a fourth embodiment of the present invention, wherein the universal multimedia bluetooth car handsfree device 5 of the present invention has the car stereo 3 connecting to a CD changer. As an operating interface and a CD changer signal interface 39 have been reserved in the design, the present invention can mimic music control sequence of the multimedia storage device 4 as the CD changer. Hence the user can operate the multimedia storage device 4 same as the CD changer. For the same purpose, a stereo output unit 56 of the present invention further includes a CD changer simulation circuit 561 to be connected to the said CD changer signal interface 39 of the car stereo 3, so that the music of the multimedia storage device 4 can be sent to the car stereo 3 through the CD changer signal interface 39 for playing.

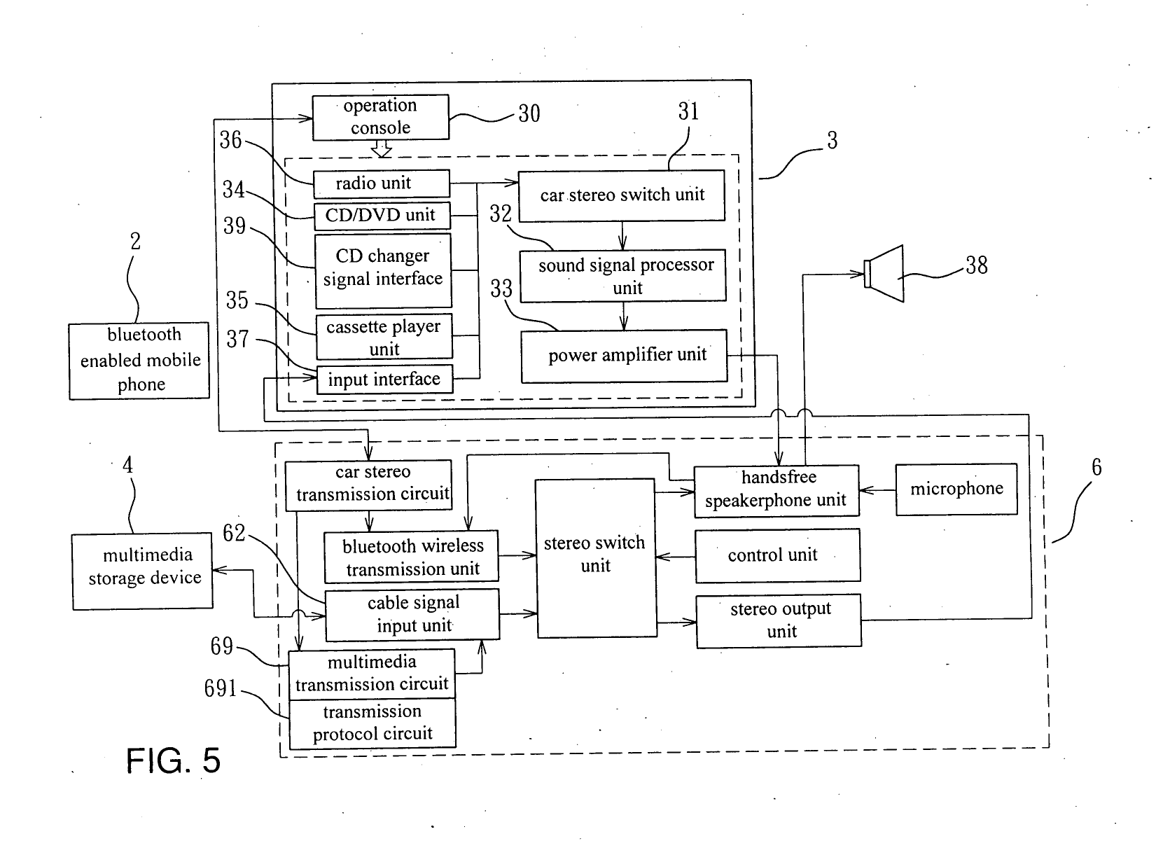

Please refer to FIG. 5 for a fifth embodiment of the present invention, in which different multimedia storage devices of different protocols (the standards of communication and data transmission formats) have been provided, such as USB storage devices conforming to a USB communication protocol, SD cards conforming to a SD card communication protocol, and iPod or Zune with its own communication protocol. Therefore the universal multimedia bluetooth car handsfree device 6 of the invention further has a multimedia transmission circuit 69 which includes a transmission protocol circuit 691 to contain communication protocols for various types of multimedia storage devices 4 to facilitate connection between a cable signal input unit 62 and the multimedia storage devices 4.

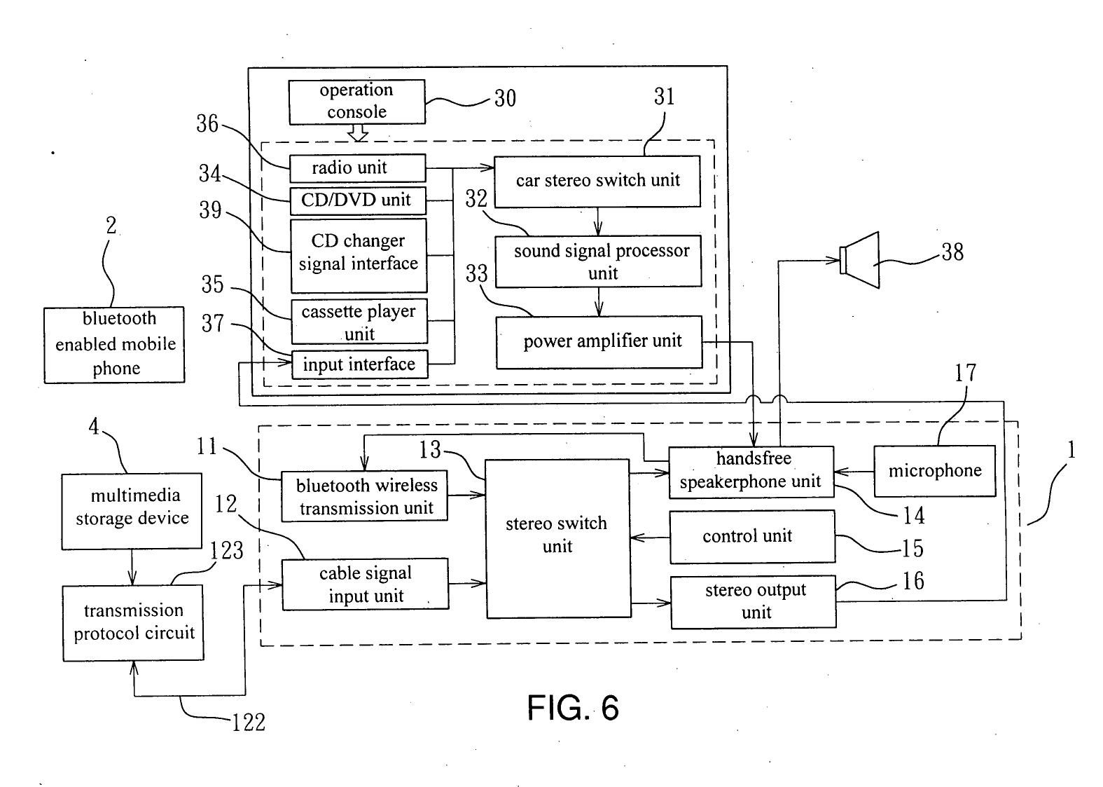

Please refer to FIG. 6 for a sixth embodiment of the present invention. It is based on the first embodiment previously discussed. It has at least one type of transmission protocol circuit 123 built in a multimedia signal cable 122 connected to the multimedia storage device 4 to be adopted to different types of the multimedia storage devices 4, thereby to connect to the multimedia storage devices 4 with various types of communication protocols.

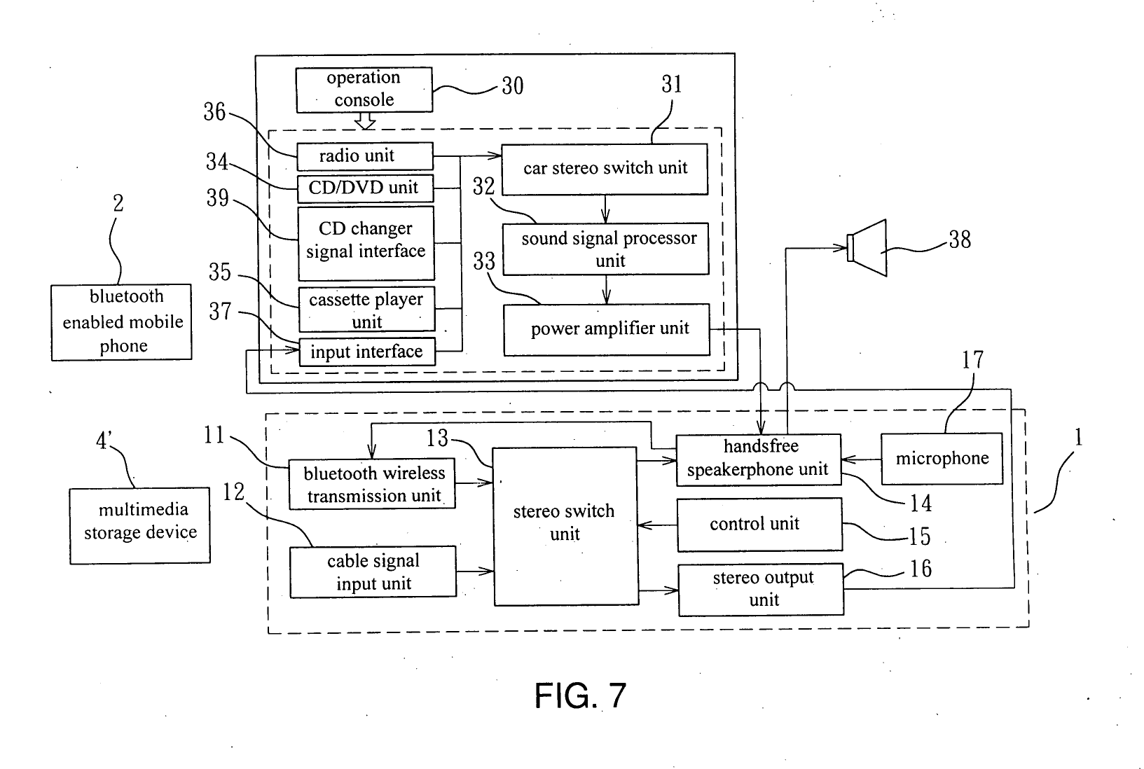

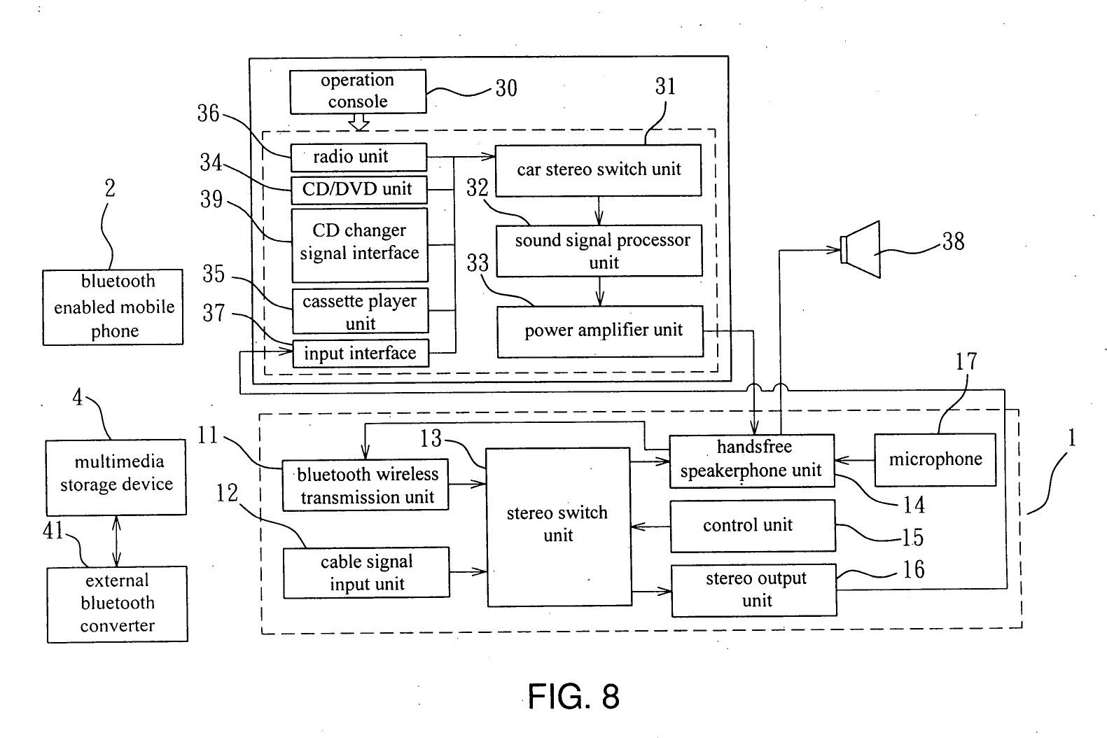

Please refer to FIG. 7 for a seventh embodiment of the present invention. It is also based on the first embodiment. A multimedia storage device 4′ can be connected to the invention through the Bluetooth function. (also may be through an external bluetooth converter 41 as shown in FIG. 8). When the multimedia storage device 4′ with bluetooth capability (or the external bluetooth converter 41) aims to play music, through the bluetooth wireless transmission unit 11 an one-way stereo mode can be established. And the control unit 15 can switch the input channel of the stereo switch unit 13 to the bluetooth wireless transmission unit 11. The music of the multimedia storage device 4′ is transmitted to the car stereo 3 through the bluetooth wireless transmission unit 11, stereo switch unit 13, and stereo output unit 16, and through the input interface 37 connecting to the car stereo switch unit 31 of the car stereo 3. Thus the user only has to switch the car stereo switch unit 31 of the car stereo 3 to the channel of the input interface 37 to enjoy the music stored in the multimedia storage devices 4′ through the car stereo 3

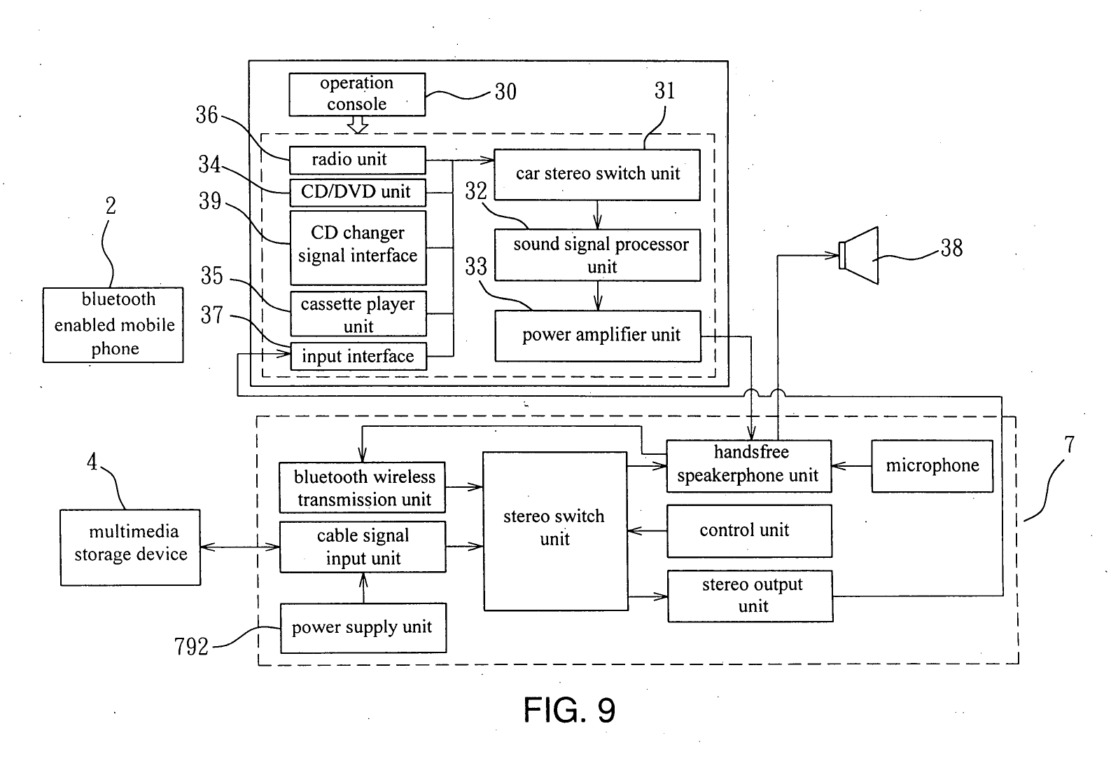

Please refer to FIG. 9 for a ninth embodiment of the present invention. As a common multimedia storage device requires electrical power to operate, it cannot be used for a long period of time even equipped with a built-in battery. To remedy this problem, the universal multimedia bluetooth car handsfree device 7 of the present invention further includes a power supply unit 792 to provide electrical power required by the multimedia storage device and charge the multimedia storage device 4 as desired.

I claim:

1. A universal multimedia bluetooth car handsfree device to be connected to a car stereo, comprising a bluetooth wireless transmission unit, a cable signal input unit, a stereo switch unit, a handsfree speakerphone unit, a control unit, and a stereo output unit, wherein:
the bluetooth wireless transmission unit has one end connecting to a bluetooth enabled mobile phone in a two-way wireless transmission fashion and sends sound output directly or indirectly to the connecting handsfree speakerphone unit and also is connected to the stereo switch unit to provide wireless conversation for the bluetooth enabled mobile phone without holding a speakerphone or music playing;
the cable signal input unit is connected to at least one multimedia storage device through at least one multimedia signal cable to receive input and outputs to the linking stereo switch unit;
the stereo switch unit receives input from the bluetooth wireless transmission unit and the cable signal input unit and sends output to control source selection for sound output;
the handsfree speakerphone unit executes phone calls of the bluetooth enabled mobile phone and performs speaker conversation through a microphone and at least one speaker;
the control unit controls at least the stereo switch unit to perform sound source input selection; and
the stereo output unit is directly or indirectly connected to an input interface of the car stereo.

2. The universal multimedia bluetooth car handsfree device as set forth in claim 1 further including a multimedia transmission circuit to perform broadcasting for the multimedia storage device.

3. The universal multimedia bluetooth car handsfree device as set forth in claim 2, wherein said multimedia transmission circuit is located in the cable signal input unit.

4. The universal multimedia bluetooth car handsfree device as set forth in claim 2, wherein the multimedia transmission circuit is located in the multimedia signal cable.

5. The universal multimedia bluetooth car handsfree device as set forth in claim 2, wherein the multimedia transmission circuit conforms to at least one type of multimedia device communication protocol.

6. The universal multimedia bluetooth car handsfree device as set forth in claim 1 further having a car stereo transmission circuit connecting to the car stereo to indirectly perform music playing for the multimedia storage device.

7. The universal multimedia bluetooth car handsfree device as set forth in claim 1 further having a car stereo transmission circuit connecting to the car stereo to indirectly perform music playing for the bluetooth enabled mobile phone.

8. The universal multimedia bluetooth car handsfree device as set forth in claim 1 further having a CD changer simulation circuit to control music playing for the multimedia storage device or the bluetooth enabled mobile phone.

9. The universal multimedia bluetooth car handsfree device as set forth in claim 1 further having a power supply unit to provide electrical power for the multimedia storage device.

10. The universal multimedia bluetooth car handsfree device as set forth in claim 1, wherein the multimedia storage device is a non-volatile memory.

11. The universal multimedia bluetooth car handsfree device as set forth in claim 1, wherein the multimedia storage device is a multimedia player equipped with a memory.
